(19) United States
(12) Patent Application Publication
(10) Pub. No.: US 2025/0361155 A1
(43) Pub. Date: Nov. 27, 2025

(54) SYNTHESIS OF GRADIENT PARTICLES BY FLAME-ASSISTED SPRAY PYROLYSIS

(71) Applicant: Massachusetts Institute of Technology, Cambridge, MA (US)

(72) Inventors: Sili Deng, Newton, MA (US); Jianan Zhang, Cambridge, MA (US); Chuwei Zhang, Cambridge, MA (US)

(21) Appl. No.: 19/214,541

(22) Filed: May 21, 2025

Related U.S. Application Data
(60) Provisional application No. 63/650,446, filed on May 22, 2024.

(51) Int. Cl. C01G 53/506

(52) U.S. Cl. CPC C01G 53/506; C01P 2002/01; C01P 2002/72; C01P 2002/85; C01P 2004/03; C01P 2004/04; C01P 2004/61; C01P 2004/64; C01P 2004/84; C01P 2006/40

(57) ABSTRACT

The present disclosure relates to a method of producing core-shell particles from a suspension comprising a plurality of core particles and a salt of a metal using flame assisted spray pyrolysis.

### RELATED APPLICATION

This application claims the benefit of priority to U.S. Provisional Patent Application No.: 63/650,446, filed May 22, 2024.

### BACKGROUND

Nickel-rich lithium-ion batteries are promising next-generation energy storage materials with high specific capacities. However, their poor cycling performance due to rapid material degradation is a major concern. Modification techniques, including doping, coating, single crystallization, and gradient structuring, have been proposed and realized by using co-precipitation and solid-state methods in order to overcome fast degradation. The existing methods have drawbacks, such as multi-step processes, non-uniform mixing, and high costs. Accordingly, better methods for manufacturing nickel-rich lithium-ion batteries are needed.

### SUMMARY OF THE INVENTION

In some embodiments, the present disclosure relates to a method of producing core-shell particles, the method comprising:
(a) combining a suspension comprising a plurality of core particles, wherein the core particles comprises a first metal; and a solution comprising a salt of a second metal; thereby producing a liquid precursor;
(b) spraying the liquid precursor; thereby producing liquid precursor droplets;
(c) heating the liquid precursor droplets; thereby producing as-synthesized core-shell particles; and
(d) calcining the as-synthesized core-shell particles; thereby producing core-shell particles.

In some embodiments, the present disclosure relates to a particle comprising a core and shell, wherein;
the core comprises a first metal;
the shell comprises an inner layer proximal to the core and an outer layer distal from the core;
the shell comprises a second metal; and
the molar concentration of the second metal in the inner layer is about 1% to about 50% higher than the molar concentration of the second metal in the outer layer.

### BRIEF DESCRIPTION OF THE DRAWINGS

FIG. 1 is a schematic depiction of a apparatus for flame-assisted spray-pyrolysis comprising a droplet atomizer (SONEAR, NS130K) with a controllable inject precursor flow rate, three preheating sections (100° C., 130° C., and 275° C.), a combustion chamber fueled by methane and air, and a powder collector with a glass fiber filter.

FIG. 2 shows SEM images of the (a) N80; (b) N71; (c) N62; and (d) N53 as-synthesized powders.

FIG. 3 shows XRPD patterns of N80, N71, N62, and N53 as synthesized powders and the reference XRPD traces of lithiated nickel oxide (Li_{0.22}Ni_{0.78}O), lithium carbonate, and nickel hydroxide.

FIG. 4 shows the following data collected for an of an N80 particle: (a) an image of TEM cross-section and EDS elements mapping; (b) a graph showing elements counts at line scan 1; (c) a graph showing atomic ratio at line scan 1; (d) a graph showing elements counts at line scan 2; and (e) a graph showing atomic ratio at line scan 2.

FIG. 5 shows the following data collected for an of an N53 particle: (a) an image of TEM cross-section and EDS elements mapping; (b) a graph showing elements counts at line scan 1; (c) a graph showing atomic ratio at line scan 1; (d) a graph showing elements counts at line scan 2; and (e) a graph showing atomic ratio at line scan 2.

FIG. 6 is a plot demonstrating the specific discharge capacity of N80, N71, N62, N53 active cathode materials.

FIG. 7 shows XRPD patterns of N80, N71, N62, N53 active cathode material (a) from 2θ=5−90° and referenced LiNiO₂ pattern; (b) the zoomed-in (108)/(110) peak pair.

FIG. 8 shows (a) SEM image of the Mn-gradient NCM particle cross-section; and (b) a plot demonstrating its normalized Ni, Co, and Mn counts along the diameter.

FIG. 9 shows (a) SEM image of the Mn-gradient NCM particle cross-section and (b) its normalized Ni, Co, Mn counts along the diameter, when the molar ratio of aqueous to solid nickel in the synthesis solution is 15:1.

FIG. 10 shows an XRPD pattern of β-phase Ni(OH)₂ nanoparticles synthesized via the precipitation reaction: 2LiOH+Ni(NO₃)₂→Ni(OH)₂↓+2LiNO₃.

FIG. 11 is a TEM image of β-phase Ni(OH)₂ nanoparticles showing size distribution of 5-10 nm.

FIG. 12 is a schematic depiction of the energy, resources, and emissions associated with (a) flame synthesis and (b) the coprecipitation method.

FIG. 13 is a schematic depiction of the typical coprecipitation steps for gradient NCM811 synthesis. NCM811 is a lithium-ion battery cathode material comprising nickel-manganese-cobalt oxides with 80% nickel content and manganese and cobalt (10% each).

FIG. 14 is a schematic description of the presently disclosed flame-assisted spray pyrolysis method of synthesis of core-shell nanoparticles.

### DETAILED DESCRIPTION OF THE INVENTION

Conventional Ni-rich-cathode improvement strategies include element doping, surface coating, and gradient structuring. Many methods—including coprecipitation, solid-state synthesis, solution washing, and physical or chemical vapor deposition—can achieve doping and surface coating. Ni-rich cathode materials with concentration gradients have emerged as promising candidates for high-energy and safe lithium-ion batteries (LIBs). These cathode materials offer enhanced energy densities and improved electrochemical performances compared to conventional cathode materials, making them attractive for various applications ranging from portable electronics to electric vehicles and grid storage systems. Gradient structuring, however, can usually be achieved only by coprecipitation, which is time-consuming and requires additional steps.

Flame synthesis reduces resource and energy consumption compared to traditional processes. Studies have shown that flame-based synthesis can cut CO₂ emissions by ˜40%, reduce water consumption by ˜25%. And ultimately, it can lower total production costs by 10-17% per unit mass of nickel-cobalt-manganese oxide (NCM) material (FIG. 12). A flame-assisted spray pyrolysis-based method (FASP) method offers greener and cheaper route to produce Ni-rich NCM cathodes.

For the gradient strategy to be further implemented, a scalable method capable of rapidly synthesizing the segregated phase needs to be developed. The FASP method is a promising cathode material production method due to its continuous flow feeding and simplified operation. Spray pyrolysis is cost-effective and suitable for continuous industrial production but has not been widely integrated with these various optimization strategies. To bridge this gap, the present disclosure explores adapting the spray pyrolysis method to the gradient-NCM strategy. In some embodiments, the full concentration gradient NCM811 and Nb-doped NCM811 were successfully synthesized using a nanoparticle-laden precursor solution and the one-step flame-assisted spray pyrolysis method. As used herein, NCM811 refers to a lithium-ion battery cathode material comprising nickel-manganese-cobalt oxides with 80% nickel content and 10% each manganese and cobalt. The high efficiency and battery performance demonstrate the advantages and potential of the proposed technology for industrial scaling up and practical battery manufacturing processes. Pristine Ni-rich cathodes can be synthesized using FASP and an aqueous precursor solution. In some embodiments, the present disclosure relates to a nanoparticle-laden FASP process that effectively synthesizes gradient Ni-rich NCM811 cathode materials. When Ni(OH)₂ is introduced into the precursor solution, the droplets automatically stratify during drying and form phase separation. Coin cell cycling results have demonstrated that the synthesized materials can be efficiently used as NCM811 cathode.

In an era marked by the urgent need for sustainable energy solutions, lithium-ion batteries (LIB) have emerged as pivotal components in the quest for clean and efficient power sources. There are four main types of LIBs prevalent in the market: the olivine type lithium iron phosphate (LFP), the layered structure lithium nickel manganese cobalt oxides (NCM), lithium nickel cobalt aluminum oxides (NCA), and lithium cobalt oxide (LCO). Among all of them, NCM was considered the most promising next-generation LIB because it overcomes the drawbacks of LFP's limited energy density (170 mAh/g) and LCO's heavy involvement of cobalt elements that have been identified as toxic to the human body if excessively exposed to it by the National Institutes of Health [1].

However, unmodified NCM811 types of material can only retain around 44% of the original capacity after 400 cycles [2] because of its fast degradation, which can be attributed to micro-cracks formation, phase reconstruction to rock-salt, internal gas release, and active material dissolution. Therefore, improvements in capacity retention are necessary to enhance the NCM's practical utility. Various strategies have been proposed, including element doping, surface coating, single-crystal formation, and gradient structural design. Among them, the gradient structural design is a promising modification method that has received more attention these days.

Previous research found that as the nickel content increases, the discharge capacity of NCM increases but is accompanied by a decrease in thermal stability and a drop in capacity retention. Therefore, in contrast to traditional NCM materials that form uniform Ni, Co, and Mn elements throughout, gradient NCM exhibits varying properties along the radial direction of the particle, constructing a high-Ni high-capacity bulk with a low-Ni highly stable surface.

The traditional gradient NCM gradient structuring is achieved by the co-precipitation method. A typical hydroxide co-precipitation includes preparation of an aqueous solution containing Ni²⁺, Mn²⁺, and Co²⁺ stoichiometrically as the precursor material. Then, ammonium solution, which works as the complexing agent, and sodium hydroxide solution, which works as pH adjuster, are injected into the transition metal solution to let the metal hydroxide precipitation happen. By precisely controlling the feeding rate of the ammonium/hydroxide solution and the chemical composition of the solutions, one can achieve different compositions across the inner and the outer parts of the precipitated particles. This co-precipitation process usually takes 12 to 24 hours of stirring and requires heating approximately at 60° C. to 80° C. under an inert atmosphere. After the precipitation, the collected precipitated hydroxide is mixed with stoichiometric lithium sources such as LiOH and or Li₂CO₃ and is subjected to an additional ˜12 hours of calcination. Although this method has been widely used in laboratories, the limitations of the co-precipitation method include 1) the involvement of a significant amount of alkali solution and wastewater that is not environmentally friendly and increases the cost of the process; 2) the use of an alkaline solution leaves residual hydroxide on the particle surface that may cause surface side reactions, and 3) the increased time cost because of the multi-steps synthesis including overnight precipitation, overnight drying, and long time calcination.

In contrast, spray pyrolysis is a promising method that benefits from a continuous synthesis process, the simple involvement of raw materials, and the uniform mixing of raw materials at the atomic level. An increasing number of energy-related materials are synthesized by the spray pyrolysis method including solid-state electrolytes, [3] fuel cell electrode [4], and Li-ion battery cathode [5][6]. Zhang et al. reported an accelerated synthesis of NCM811 cathode using flame-assisted spray pyrolysis with urea as an additive that reduces the NCM811 preparation time to only 20 minutes [5]. Zhu et al. reported the synthesis of sub-micron single crystal NCM811 by spray pyrolysis that avoids the addition of molten salt flux [6]. Zang et al. also did an economic analysis of using FSP to produce NCM cathode material, which demonstrated that the minimum cathode material selling price (MCSP) of FSP NCM 333 is $19.1/kg, which is 17% lower than co-precipitation [7]. In sum, the spray pyrolysis method could speed up the synthesis process, enable uniform mixing, and have the potential for industrial scaling up.

While the spray pyrolysis method is cost-effective and suitable for continuous industrialization, it lacks effective integration with the gradient NCM optimization strategies. In some embodiments, the present disclosure describes the synthesis of gradient-NCM material using the flame-assisted spray pyrolysis method and evaluates the powder properties synthesized by FASP.

### Ni-Poor Surface NCM811 Realization

Synthesis of particles is described in Example 1. FIG. 2 shows SEM images of the as-synthesized powders (ASPs) N80, N71, N62, and N53. The powders have sizes ranging from 2-10 micrometers in all cases. N80 and N71 powders display similar appearance, both forming roughly 4 μm spheres with slightly wrinkled surfaces. N62 powders exhibit shriveled surfaces and smaller sizes, around 3 μm. N53 powders have the largest powder size ranging from 6 to 8 um, featuring porous wrinkles that distinctly differ from the shriveled appearance of N62. From the SEM images, it can be concluded that the ratio of nanopowders to the dissolvable salt could influence the appearance of the powders under the given experimental conditions. N71 shows a similar appearance to N80, which may be attributed to the smallest portion of nanoparticle addition in the precursor solution. The diffusivity of the solution could be influenced by the solid particle volume fraction in that solution [8], and higher solid particle concentration could lead to a slower ion diffusivity. As the concentration of nanoparticles increases, the presence of nanoparticles can affect the redistribution of the composition and the formation of the crust, thereby leading to various appearances.

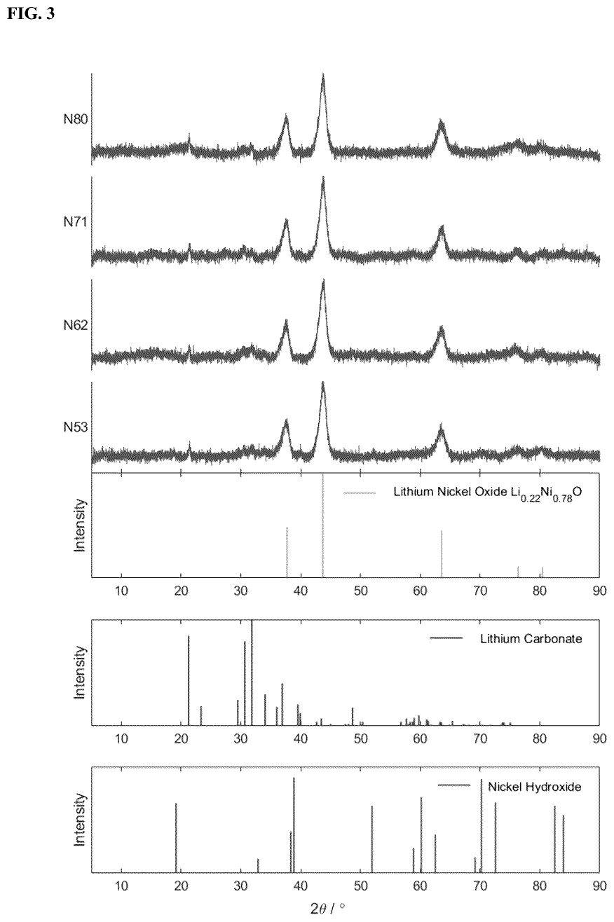

XRD was conducted to confirm the crystal structures and phases present in the as-synthesized powder. FIG. 3 shows the XRD pattern for the four ASPs, partial lithiated nickel oxides, lithium carbonate, and nickel hydroxide. Four ASP samples displayed similar amorphous phases, with peaks predominantly corresponding to partially lithiated nickel oxide Li_{0.22}Ni_{0.78}O. This indicates the complete decomposition of nitrate salt precursor, and a simultaneous lithiation happens in the FASP. However, a subtle peak around 2θ=21° indicates the presence of a small amount of lithium carbonate. The presence of lithium carbonate was likely due to the CO₂ incorporation during methane combustion. Notably, the absence of a Ni(OH)₂ signal in the as-synthesized powder confirms the complete decomposition of nickel hydroxide. This aligns with the results of the published literature, which report that nickel hydroxide decomposes into nickel oxide at temperatures ranging from 200 to 300° C.

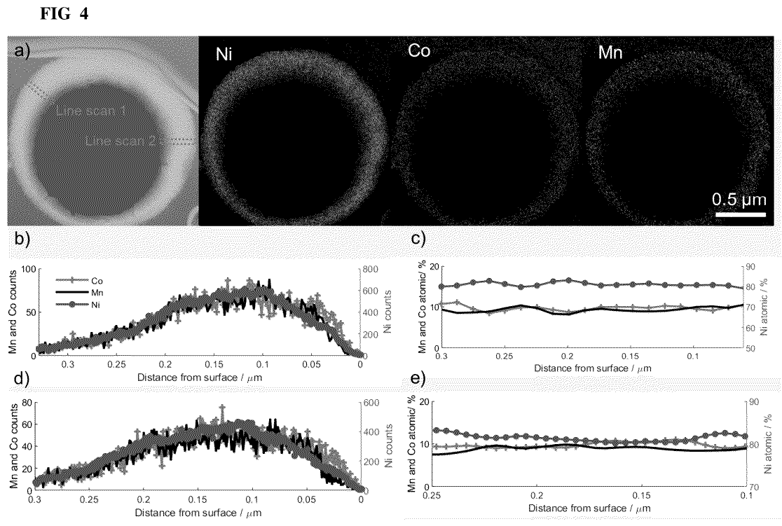

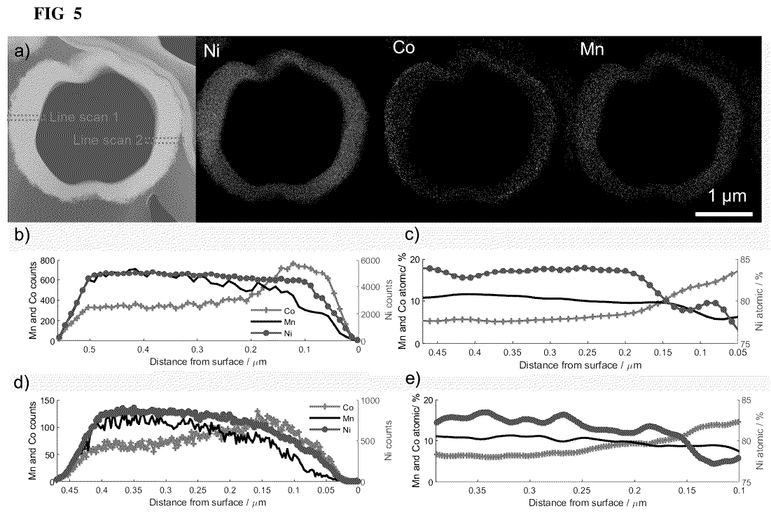

The as-synthesized N80 and N53 powders were chosen for cross-sectional elemental mapping. The TEM imaging of the cross-sectional surface and the Ni, Co, and Mn counts of a representative N80 particle is shown in FIG. 4, panel (a). The elements displayed overall stronger signals at the center of the shell area, denoting the thicker region near the center. However, the segregation of elements was not discernible to the naked eye. To further investigate this, radial line scans were conducted on line 1 and 2, as illustrated in FIG. 4, panel s (b) and (d). The signal intensity showed that the three elements share the same distribution trend across the radial direction. The corresponding atomic percentage of these three elements is shown in FIG. 4, panels (c) and (e). Positions near the surface were excluded from this atomic percentage analysis due to weak signals and high uncertainty. With the precision afforded, the ratio of Ni, Co, and Mn remained approximately 8:1:1 across the radial direction. Accordingly, the cross-section and elements mapping of a representative particle from the N53 powder was displayed in FIG. 5, panel (a). Compared to the N80 counterpart, the N53 particle was less spherical, which was consistent with its wrinkled surface shown in the SEM imaging. The EDS mapping suggested a noticeable enrichment of cobalt on the surface area. Panels (b) and (d) of FIG. 5 show two radial line scans confirmed this enrichment. Nickel content gradually decreases from the inner surface to the outer surface, and the cobalt element content gradually climbs up from the inner to outer parts. Panels (c) and (e) of FIG. 5 show the atomic percentages of the three elements; the nickel content is about 85%, slightly higher than the 80% in the precursor. Near the surface area, the nickel content drops below 80%, which aligns with the mass conservation law. In summary, a gradient structure with a nickel-rich interior and a cobalt-rich surface was successfully established.

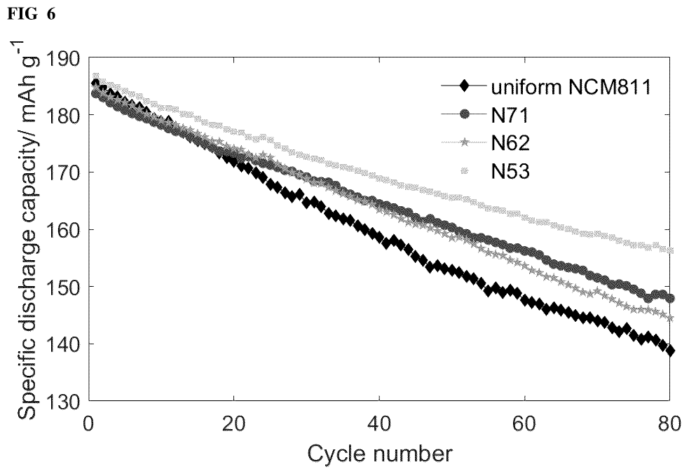

The ASP was further calcinated into active cathode material and made into coin cells. The initial activation cycle of each N80, N71, N62, and N53 displayed 200.22, 199.43, 201.24, and 202.13 mAh/g specific discharge capacity, respectively. The narrow distribution of the initial specific discharge capacity suggested that incorporating nickel hydroxide nanoparticles into the precursor does not affect the initial specific discharge capacity, given that the materials' total nickel content remained constant. FIG. 6 displays the specific discharge capacities of these cathode materials over subsequent cycles. At the first 0.5 C cycle, N80, N71, N62, and N53 exhibited specific discharge capacities of 185.5, 183.7, 183.7, and 187.3 mAh/g, respectively. N53 had the highest specific discharge capacity, and N80's capacity initially fell within the range of the other samples. However, only after 15 cycles did N71 and N62 display higher discharge capacities than N80. By the 80th cycle, N80, N71, N62, and N53 each maintained 76, 80, 79, and 84% of their initial capacity. These results reveal that N53, N62, and N71 had better capacity retention over the N80 sample, indicating that the method indeed benefits the electrochemical performances of NCM811.

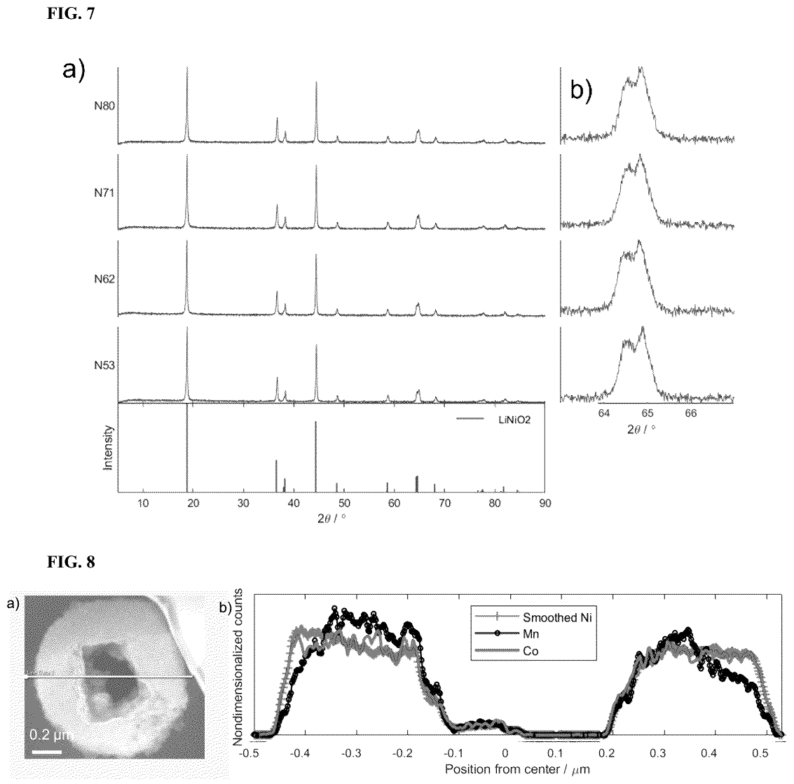

XRD analysis was conducted to identify the crystal structure of the calcined cathode materials, as shown in FIG. 7, panel (a). All four samples display the α-NaFeO₂ type peak pattern, indicating the pure phase of NCM cathode material. FIG. 7, panel (b) illustrated the zoomed-in splitting peaks pairs of (108)/(110), which represents an ordered layered structure.

### Transferability

The nanoparticles corresponding to the manganese element were tested to demonstrate the transferability of nanoparticle-induced gradient structure. The total molar concentration of 0.5 mol/L and the ratio of Li, Ni, Co, and Mn sources remained unchanged at 1.07:0.8:0.1:0.1, precursors of Li, Ni, and Co remained as its nitrate solution, but the Mn source was changed to manganese hydroxide. Precursor preparation was done in a low-oxygen environment to avoid the oxidation of manganese hydroxide as much as possible. The precursor was spray pyrolyzed, collected, TEM-lifted, and subjected to EDS testing. Panel (a) of FIG. 8 shows the cross-section of the selected particle, and a line scanning was done alone with the indicated diameter. Panel (b) of FIG. 8 displayed the normalized element counts in the diameter line scan. The data showed a clear element separation of Mn from Ni and Co that formed a full concentration gradient from the center to the surface. By changing the nanoparticles from nickel to manganese, particles with nickel-cobalt-rich and manganese-poor surfaces have been synthesized.

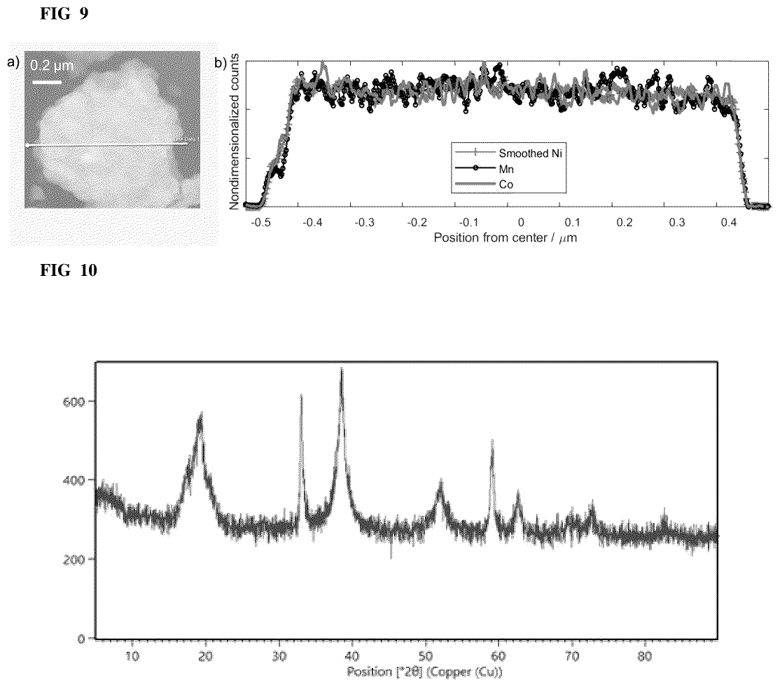

However, an ultra-dilute nanoparticle experiment suggests that a sufficient quantity of nanoparticles is critical for the successful formation of a gradient structure. In this experiment, the molar ratio of aqueous to solid nickel was adjusted to 15:1, and the subsequent EDS mapping revealed the absence of a discernible gradient structure, as illustrated in FIG. 9.

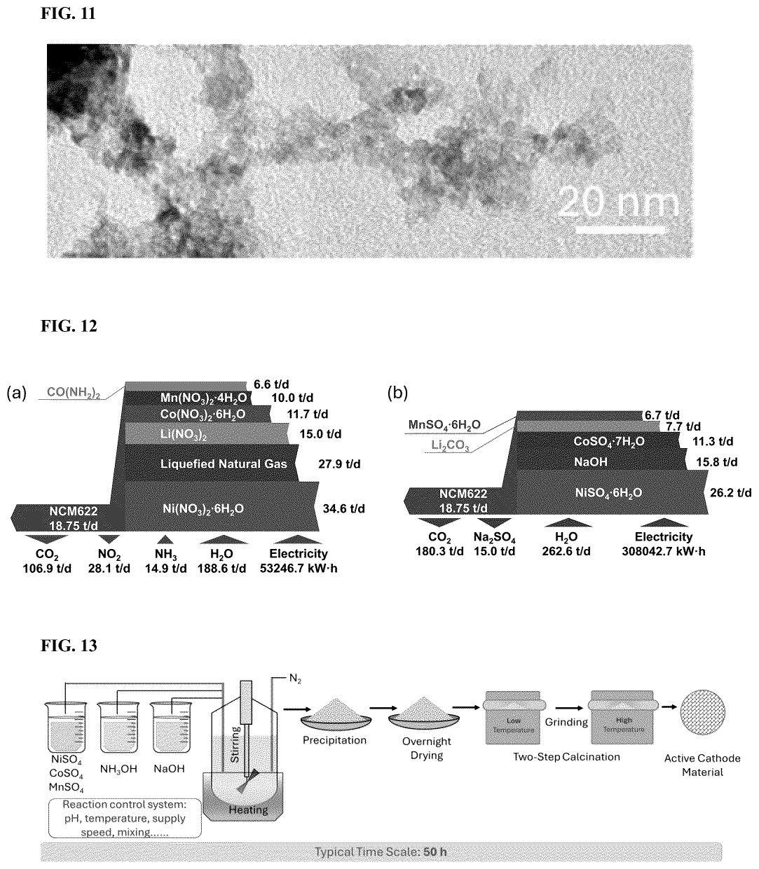

The FASP method features a significantly reduced synthesis time. Ni(OH)₂ could be purchased from external vendors or synthesized on the spot before the experiments. Alternatively, the Ni(OH)₂-comprising suspension can be prepared in situ. A stoichiometric 1M LiOH solution and 0.5 M Ni(NO₃)₂ solution were mixed directly, triggering the precipitation reaction: 2LiOH+Ni(NO₃)₂→Ni(OH)₂↓+2LiNO₃ (or 2LiOH+Mn(NO₃)₂→Mn(OH)₂↓+2LiNO₃ in the Mn nanoparticle case), which produced a LiNO₃ solution with Ni(OH)₂ nanoparticle suspension. The nanoparticles were collected and dried to test their chemical composition. The powder showed a similar light turquoise color and matched the corresponding β-phase Ni(OH)₂ XRD peaks (FIG. 10). A TEM image confirms their typical size range of around 5 to 10 nm (FIG. 11). This size is much smaller than the droplet size (˜1 to 20 μm), ensuring successful carrying (dispersion).

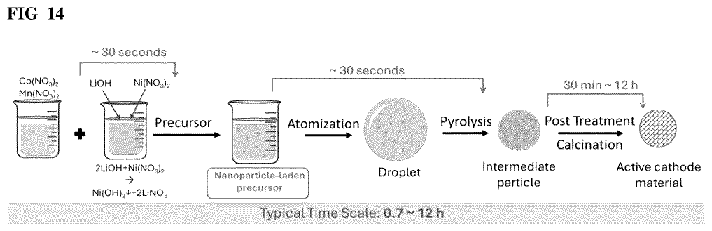

The suspension was directly mixed with stoichiometric Co(NO₃)₂ and Mn(NO₃)₂ without filtration, forming the target nanoparticle-laden precursor. This precipitation was complete within ˜30 seconds, and the precursor was immediately ready for FASP. The solution was then atomized into tiny droplets and injected into a flame front, where each droplet undergoes pyrolysis—thermally decomposing into an intermediate powder. Remarkably, the FASP pyrolysis itself required less than 30 seconds. The as-synthesized powder was collected and subjected to calcination post-treatment, converting it into active NCM811 material for battery fabrication. Calcination typically takes 0.5-12 hours, depending on synthesis conditions. Thus, the total process time for nanoparticle-laden FASP (0.5-12 hours) is drastically shorter than traditional methods (FIGS. 13 and 14).

In some embodiments, the present disclosure relates to the flame-assisted spray pyrolysis synthesis of gradient NCM811. Gradient structuring of the NCM811 material was successfully achieved by replacing the pure solution with the nanoparticle-laden precursor. The TEM line scan confirms the gradient structure in the N53-NCM811, whose precursor consists of 5/8 aqueous nickel and 3/8 solid nanoparticle nickel. The Ni content at the inner part of a radius is roughly 85%; near the surface area, the number drops to 75%. The coin cell electrochemical cycling tests reveal that N53 material has superior initial specific discharge capacity and battery retention percentage compared to the N80 counterpart. In addition, the transferability experiments prove that this aqueous/nanoparticle method could also be used in other transition metals, such as manganese. Different gradient degrees were achieved, indicating that FASP has the potential to control the process effectively. An advantage of using FASP to generate the gradient cathode material is its efficiency. From the atomization of the precursor to the as-synthesis powder collection, the process takes less than 30 seconds, whereas conventional multistep co-precipitation takes tens of hours. This remarkable efficiency underscores the practical benefits of adopting FASP for rapid and scalable synthesis of advanced battery materials.

### Definitions

For convenience, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

In order for the present invention to be more readily understood, certain terms and phrases are defined below and throughout the specification.

The articles “a” and “an” are used herein to refer to one or to more than one (i.e., to at least one) of the grammatical object of the article. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Numeric ranges are inclusive of the numbers defining the range. Measured and measureable values are understood to be approximate, taking into account significant digits and the error associated with the measurement. As used in this application, the terms “about” and “approximately” have their art-understood meanings; use of one vs. the other does not necessarily imply different scope. Unless otherwise indicated, numerals used in this application, with or without a modifying term such as “about” or “approximately”, should be understood to encompass normal divergence and/or fluctuations as would be appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of a stated reference value unless otherwise stated or otherwise evident from the context (except where such number would exceed 100% of a possible value).

As used herein, “average particle size,” “average diameter of the particle,” “mean particle diameter,” or “D50 particle size” refers to a particle diameter corresponding to 50% of the particles in a distribution curve in which particles are accumulated in the order of particle diameter from the smallest particle to the largest particle and a total number of accumulated particles is 100%. The mean particle diameter may be measured by methods known to those of skill in the art. For example, the mean particle diameter may be as determined with a commercially available particle size analyzer by, e.g., dynamic light scattering, or may be measured using a transmission electron microscope (TEM) or a scanning electron microscope (SEM). When determined by TEM or SEM, an average longest dimension of a particle may be used.

In some embodiments, the present disclosure relates to a method of producing core-shell particles, the method comprising:
(a) combining a suspension comprising a plurality of core particles, wherein the core particles comprises a first metal; and a solution comprising a salt of a second metal; thereby producing a liquid precursor;
(b) spraying the liquid precursor; thereby producing liquid precursor droplets;
(c) heating the liquid precursor droplets; thereby producing as-synthesized core-shell particles; and
(d) calcining the as-synthesized core-shell particles; thereby producing core-shell particles.

In some embodiments, the suspension comprises a solvent and the core particle is insoluble or substantially insoluble in the solvent.

In some embodiments, spraying the liquid precursor comprises atomizing the liquid precursor using an ultrasonic nebulizer.

In some embodiments, heating the liquid precursor droplets comprises contacting the liquid precursor droplets with a flame.

In some embodiments, heating the liquid precursor droplets further comprises preheating the liquid precursor droplets prior to contacting the liquid precursor droplets with a flame.

In some embodiments, preheating the liquid precursor droplets comprises passing the liquid precursor droplets through a first preheating chamber at about 50° C. to about 150° C.; a second preheating chamber at about 80° C. to about 200° C.; and a third preheating chamber at about 250° C. to about 300° C.

In some embodiments, preheating the liquid precursor droplets comprises passing the liquid precursor droplets through a first preheating chamber at about 100° C.; a second preheating chamber at about 130° C.; and a third preheating chamber at about 275° C.

In some embodiments, calcining the as-synthesized core-shell particles comprises heating the as-synthesized core-shell particles to a temperature of about 600° C. to about 1000° C. for a period of time of about 0.5 to about 15 hours.

In some embodiments, the core particle comprises Ni(OH)₂, NiO, NiCO₃, NiC₂O₄, Mn(OH)₂, MnO, MnCO₃, MnC₂O₄, Co(OH)₂, CoO, CoCO₃, or CoC₂O₄, or a combination of any of them.

In some embodiments, the core particle comprises Ni(OH)₂.

In some embodiments, the core particle comprises Mn(OH)₂.

In some embodiments, the average diameter of the core particle is about 1 nm to about 1000 nm.

In some embodiments, the average diameter of the core particle is about 1 nm to about 100 nm.

In some embodiments, the average diameter of the core particle diameter is about 5 nm to about 10 nm.

In some embodiments, the method further comprises
(i) providing a solution comprising a salt of the first metal; and
(ii) adding a reagent to the solution comprising the salt of the first metal resulting in precipitation of the core particles, thereby generating the suspension comprising the plurality of core particles.

In some embodiments, the reagent is selected from the group consisting of LiOH, NaOH, KOH, NH₃, Li₂CO₃, LiHCO₃, oxalic acid, and Li₂C₂O₄, or a combination of any of them.

In some embodiments, the reagent is LiOH.

In some embodiments, the first metal is selected from the group consisting of Ni, Mn, Co, Nb, Mg, and Fe, or a combination of any of them.

In some embodiments, the first metal is Ni.

In some embodiments, the first metal is Mn.

In some embodiments, the molar ratio of the first metal to the second metal in the liquid precursor is about 0.05 to about 5.

In some embodiments, the molar ratio of the first metal to the second metal in the liquid precursor is about 0.1 to about 0.6.

In some embodiments, the molar ratio of the first metal to the second metal in the liquid precursor is about 0.12, about 0.25, about 0.37, or about 0.5.

In some embodiments, the second metal is selected from the group consisting of Ni, Co, Mn, Li, Mg, Al, and Fe, or a combination of any of them.

In some embodiments, the first metal and the second metal are the same.

In some embodiments, the first metal and the second metal are Ni.

In some embodiments, the salt of the second metal is selected from the group consisting of a nitrate, a chloride, a bromide, a sulfate, and an acetate of the second metal, or a combination of any of them.

In some embodiments, the liquid precursor further comprises Li, Co, and Mn.

In some embodiments, the molar ratio of Ni to Li in the liquid precursor is about 0.1 to about 10.

In some embodiments, the molar ratio of Ni to Li in the liquid precursor is about 0.5 to about 2.

In some embodiments, the molar ratio of Ni to Li in the liquid precursor is about 0.75.

In some embodiments, the molar ratio of Ni:Mn in the liquid precursor is about 2 to about 20; and the molar ratio of Ni:Co in the liquid precursor is about 2 to about 20.

In some embodiments, the molar ratio of Ni:Mn in the liquid precursor is about 5 to about 10; and the molar ratio of Ni:Co in the liquid precursor is about 5 to about 10.

In some embodiments, the molar ratio of Ni:Mn in the liquid precursor is about 8; and the molar ratio of Ni:Co in the liquid precursor is about 8.

In some embodiments, the as-synthesized core-shell particle comprises a core and shell;
the shell comprises an inner layer proximal to the core and an outer layer distal from the core; and
the molar concentration of second metal in the inner layer is about 1% to about 50% higher than the molar concentration of the second metal in the outer layer.

In some embodiments, the molar concentration of second metal in the inner layer is about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 25%, about 10% to about 20%, or about 10% to about 15%, about 15% to about 50%, about 15% to about 45%, about 15% to about 40%, about 15% to about 35%, about 15% to about 30%, about 15% to about 25%, about 15% to about 20%, about 20% to about 50%, about 20% to about 45%, about 20% to about 40%, about 20% to about 35%, or about 20% to about 30%, about 20% to about 25% higher than the molar concentration of the second metal in the outer layer.

In some embodiments, the second metal is Ni; and the molar concentration of Ni in the inner layer is about 1% to about 30% higher than the molar concentration of Ni in the outer layer.

In some embodiments, the molar concentration of Ni in the inner layer is about 5% to about 25% higher than the molar concentration of Ni in the outer layer.

In some embodiments, the molar concentration of Ni in the inner layer is about 10% higher than the molar concentration of Ni in the outer layer.

In some embodiments, the as-synthesized core-shell particle comprises a core and shell;
the shell comprises an inner layer proximal to the core and an outer layer distal from the core;
   the shell further comprises a third metal that is different from the second metal; and
the molar concentration of the third metal in the inner layer is about 1% to about 50% lower than the molar concentration of the second metal in the outer layer.

In some embodiments, the molar concentration of third metal in the inner layer is about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 25%, about 10% to about 20%, or about 10% to about 15%, about 15% to about 50%, about 15% to about 45%, about 15% to about 40%, about 15% to about 35%, about 15% to about 30%, about 15% to about 25%, about 15% to about 20%, about 20% to about 50%, about 20% to about 45%, about 20% to about 40%, about 20% to about 35%, or about 20% to about 30%, about 20% to about 25% lower than the molar concentration of the second metal in the outer layer.

In some embodiments, the third metal is selected from Ni, Co, Mn, Li, Mg, Al, and Fe, or a combination of any of them.

In some embodiments, the third metal is Co; and
the molar concentration of Co in the inner layer is about 1% to about 50% lower than the molar concentration of Co in the outer layer.

In some embodiments, the molar concentration of Co in the inner layer is about 5% to about 25% lower than the molar concentration of Co in the outer layer.

In some embodiments, the molar concentration of Co in the inner layer is about 7% lower than the molar concentration of Co in the outer layer.

In some embodiments, the average diameter of the as-synthesized core-shell particle diameter is about 1 μm to about 20 μm.

In some embodiments, the average diameter of the as-synthesized core-shell particle diameter is about 2 μm to about 10 μm.

In some embodiments, the average diameter of the as-synthesized core-shell particle diameter is about 3 μm to about 8 μm.

In some embodiments, the present disclosure relates to a particle comprising a core and shell, wherein;
the core comprises a first metal;
the shell comprises an inner layer proximal to the core and an outer layer distal from the core;
the shell comprises a second metal; and
the molar concentration of the second metal in the inner layer is about 1% to about 50% higher than the molar concentration of the second metal in the outer layer.

In some embodiments, the molar concentration of second metal in the inner layer is about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 25%, about 10% to about 20%, or about 10% to about 15%, about 15% to about 50%, about 15% to about 45%, about 15% to about 40%, about 15% to about 35%, about 15% to about 30%, about 15% to about 25%, about 15% to about 20%, about 20% to about 50%, about 20% to about 45%, about 20% to about 40%, about 20% to about 35%, or about 20% to about 30%, about 20% to about 25% higher than the molar concentration of the second metal in the outer layer.

In some embodiments, the molar concentration of the second metal in the inner layer is about 5% to about 25% higher than the molar concentration of second metal in the outer layer.

In some embodiments, the molar concentration of second metal in the inner layer is about 10% higher than the molar concentration of second metal in the outer layer.

In some embodiments, the first metal is selected from the group consisting of Ni, Mn, Co, Nb, Mg, and Fe, or a combination of any of them.

In some embodiments, the first metal is Ni.

In some embodiments, the first metal is Mn.

In some embodiments, the second metal is selected from the group consisting of Ni, Co, Mn, Li, Mg, Al, and Fe, or a combination of any of them.

In some embodiments, the first metal and the second metal are the same.

In some embodiments, the first metal and the second metal are Ni.

In some embodiments, the shell further comprises a third metal and wherein the third metal is different from the second metal.

In some embodiments, the molar concentration of the third metal in the inner layer is about 1% to about 50% lower than the molar concentration of the third metal in the outer layer.

In some embodiments, the molar concentration of third metal in the inner layer is about 1% to about 45%, about 1% to about 40%, about 1% to about 35%, about 1% to about 30%, about 1% to about 25%, about 1% to about 20%, about 1% to about 15%, about 1% to about 10%, about 1% to about 5%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 50%, about 10% to about 45%, about 10% to about 40%, about 10% to about 35%, about 10% to about 30%, about 10% to about 25%, about 10% to about 20%, or about 10% to about 15%, about 15% to about 50%, about 15% to about 45%, about 15% to about 40%, about 15% to about 35%, about 15% to about 30%, about 15% to about 25%, about 15% to about 20%, about 20% to about 50%, about 20% to about 45%, about 20% to about 40%, about 20% to about 35%, or about 20% to about 30%, about 20% to about 25% lower than the molar concentration of the second metal in the outer layer.

In some embodiments, the molar concentration of the third metal in the inner layer is about 5% to about 25% lower than the molar concentration of the third metal in the outer layer.

In some embodiments, the molar concentration of the third metal in the inner layer is about 7% less than the molar concentration of the third metal in the outer layer.

In some embodiments, the third metal is Co.

In some embodiments, the core comprises Ni; and the shell comprises Li, Ni, Mn, and Co.

In some embodiments, the core comprises Mn; and the shell comprises Li, Ni, Mn, and Co.

In some embodiments, the particle comprises lithiated nickel oxide, lithium carbonate, and nickel hydroxide.

In some embodiments, the molar ratio of Ni, Co, and Mn in the shell is about 50:1:1 to about 1:1:1.

In some embodiments, the molar ratio of Ni, Co, and Mn in the shell is about 8:1:1.

In some embodiments, the average particle size is about 2 μm to about 10 μm.

In some embodiments, the average particle size is about 3 μm to about 8 μm.

In some embodiments, the core comprises a plurality of core particles.

In some embodiments, the average diameter of the core particle is about 1 nm to about 1000 nm.

In some embodiments, the average diameter of the core particle is about 1 nm to about 100 nm.

In some embodiments, the average diameter of the core particle is about 5 nm to about 10 nm.

### REFERENCES CITED

[1] National Institutes of Health. (2024). Cobalt toxicity. Retrieved Apr. 22, 2024, from https://www.ncbi.nlm.nih.gov/books/NBK587403/
[2] Zhang, R., Wang, C., Zou, P., Lin, R., Ma, L., Yin, L., . . . & Xin, H. L. (2022). Compositionally complex doping for zero-strain zero-cobalt layered cathodes. Nature, 610(7930), 67-73.
[3] Muldoon, V. L. (2022). Scalable Synthesis of Solid-State Electrolytes Using Flame-Assisted Spray Pyrolysis (Doctoral dissertation, Massachusetts Institute of Technology).
[4] Liu, L., Kim, G. Y., & Chandra, A. (2010). Fabrication of solid oxide fuel cell anode electrode by spray pyrolysis. Journal of Power Sources, 195(20), 7046-7053.
[5] Zhang, J., Muldoon, V. L., & Deng, S. (2022). Accelerated synthesis of Li(Ni0.8Co0.1Mn0.1)O2 cathode materials using flame-assisted spray pyrolysis and additives. Journal of Power Sources, 528, 231244.
[6] Zhu, J., Zheng, J., Cao, G., Li, Y., Zhou, Y., Deng, S., & Hai, C. (2020). Flux-free synthesis of single-crystal LiNi0.8Co0.1Mn0.1O2 boosts its electrochemical performance in lithium batteries. Journal of Power Sources, 464, 228207.
[7] Zang, G., Zhang, J., Xu, S., & Xing, Y. (2021). Techno-economic analysis of cathode material production using flame-assisted spray pyrolysis. Energy, 218, 119504.
[8] Silva, M. A., Kerkhof, P. J., & Coumans, W. J. (2000). Estimation of effective diffusivity in drying of heterogeneous porous media. Industrial & engineering chemistry research, 39(5), 1443-1452.

### EXAMPLES

The invention now being generally described, it will be more readily understood by reference to the following examples which are included merely for purposes of illustration of certain aspects and embodiments of the present invention and are not intended to limit the invention.

### Example 1. FASP Particle Synthesis

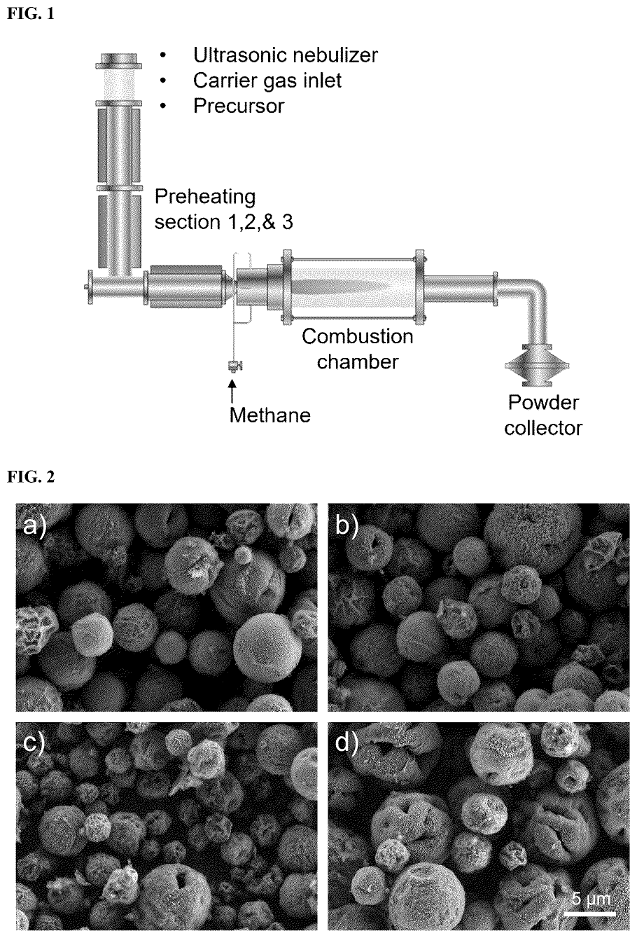

FIG. 1 is the schematic illustration of the FASP for NCM cathode material. It consists of a droplet atomizer (SONEAR, NS130K) with a controllable inject precursor flow rate, three preheating sections with 100° C., 130° C., and 275° C., a combustion chamber fueled by methane and air, and a powder collector with a glass fiber filter.

Lithium nitrate (LiNO₃), nickel nitrate hexahydrate (Ni(NO₃)₂·6H₂O), manganese nitrate tetrahydrate (Mn(NO₃)₂·4H₂O), cobalt nitrate hexahydrate (Co(NO₃)₂·6H₂O) was dissolved in deionized water with additional nickel hydroxide (Ni(OH)₂) nanoparticles to achieve the final Li:Ni:Mn:Co molar ratio equaled 1.07:0.8:0.1:0.1 and a final concentration 0.25 mol/L. Within the 0.8 parts Ni elements, x (x=0, 0.1, 0.2, 0.3) parts were nanoparticle Ni and (0.8−x) were aqueous Ni. The suspension was sealed in a syringe and kept stirring for one hour.

The precursor solution was injected into the droplet generator chamber and atomized by the ultrasonic nebulizer. Then, the carrier gas, with an air flow rate ranging from 10 L/min (LPM), transported the droplet aerosol through the preheating sections. After exiting the preheating zone, the partially dried, partially decomposed droplets passed through the flame, which was fueled by a premixed flow of 1.1 LPM methane and 22 LPM air. The filter then captured the dried particles, referred to as-synthesized powder (ASP). The ASPs, corresponding to x values of 0, 0.1, 0.2, and 0.3, were named N80, N71, N62, and N53, respectively. Later, the ASP was placed in alumina crucibles and positioned inside a tube furnace with oxygen flowing at 0.5 LPM and a heating temperature of 850° C. for 12 hours. After calcination, the materials are referred to as active cathode materials.

### Example 2. FASP Particle Synthesis With In Situ Generated Nanoparticles

A stoichiometric 1 M LiOH solution and 0.5 M Ni(NO₃)₂ solution were mixed directly, triggering the precipitation of Ni(OH)₂ nanoparticles. The resulting suspension was directly mixed with stoichiometric Co(NO₃)₂ and Mn(NO₃)₂ without filtration, forming the target nanoparticle-laden precursor (Li:Ni:Mn:Co molar ratio equaled 1.07:0.8:0.1:0.1). This precipitation was complete within ˜30 seconds, and the precursor was immediately ready for FASP. The solution was then atomized into tiny droplets and injected into a flame front, where each droplet underwent flame-assisted pyrolysis, collection, and calcination according to the procedure described in Example 1.

### Example 3. Particle Characterization

Scanning electron microscopy (SEM) imaging is performed on the Zeiss Merlin high-resolution scanning electron microscope with 3 kV accelerating voltage. X-ray diffraction (XRD) is conducted to determine the crystal structure by the PANalytical X'Pert PRO X-ray diffractometer. Energy dispersive spectroscopy (EDS) is conducted on Zeiss Merlin high-resolution scanning electron microscope, Hitachi HF5000 environmental transmission electron microscope (ETEM), and Themis Z G3 Cs-Corrected S/TEM to determine the element distribution. Specifically, the TEM laminar sample was prepared by focused ion beam (FIB) on FEI Helios Nanolab 600 Dual Beam Machine.

### Example 4. Electrochemical Studies

Active cathode material (as prepared in Example 1 or 2), carbon black, polyvinylidene fluoride (PVDF) binder, N-Methylpyrrolidone (NMP), and yttria-stabilized zirconia milling media (3 mm diameter) were mixed with the mass ratio 8:1:1 to form a slurry. Once mixed, the slurry is manually tape-casted by a doctor blade with a gap height of 200 μm on an aluminum foil (15 μm). The coated film was dried in a vacuum oven at 100° C. overnight, cut into 1 cm diameter discs, and then pressed at 5 MPa. After that, the cathode electrode discs were assembled as coin cells with Li chips anode, a separator, and a commercial electrolyte consisting of 1 mol/L LiPF₆ dissolving in ethylene carbonate (EC) and diethyl carbonate (DEC) whose volume ratio equals to 1:1. The galvanostatic charge-discharge study was performed using a Land CT3001A battery tester in the potential range of 2.7-4.3 V at different C-rates (1 C=200 mA/g).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of producing core-shell particles, the method comprising:
(a) combining a suspension comprising a plurality of core particles, wherein the core particles comprise a first metal; and a solution comprising a salt of a second metal; thereby producing a liquid precursor;
(b) spraying the liquid precursor; thereby producing liquid precursor droplets;
(c) heating the liquid precursor droplets; thereby producing as-synthesized core-shell particles; and
(d) calcining the as-synthesized core-shell particles; thereby producing core-shell particles.

2.-7. (canceled)

8. The method of claim 1, wherein the core particle comprises Ni(OH)₂, NiO, NiCO₃, NiC₂O₄, Mn(OH)₂, MnO, MnCO₃, MnC₂O₄, Co(OH)₂, CoO, CoCO₃, or CoC₂O₄, or a combination of any of them.

9.-13. (canceled)

14. The method of claim 1, further comprising
(i) providing a solution comprising a salt of the first metal; and
(ii) adding a reagent to the solution comprising the salt of the first metal resulting in precipitation of the core particles, thereby generating the suspension comprising the plurality of core particles.

15. The method of claim 14, wherein the reagent is selected from the group consisting of LiOH, NaOH, KOH, NH₃, Li₂CO₃, LiHCO₃, oxalic acid, and Li₂C₂O₄, or a combination of any of them.

16.-17. (canceled)

18. The method of claim 1, wherein the first metal is selected from the group consisting of Ni, Mn, Co, Nb, Mg, and Fe, or a combination of any of them.

19-24. (canceled)

25. The method of claim 1, wherein the second metal is selected from the group consisting of Ni, Co, Mn, Li, Mg, Al, and Fe, or a combination of any of them.

26. (canceled)

27. The method of claim 1, wherein the first metal and the second metal are Ni.

28. (canceled)

29. The method of claim 27, wherein the liquid precursor further comprises Li, Co, and Mn.

30.-33. (canceled)

34. The method of claim 29, wherein
the molar ratio of Ni:Mn in the liquid precursor is about 5 to about 10; and
the molar ratio of Ni:Co in the liquid precursor is about 5 to about 10.

35. (canceled)

36. The method of claim 1, wherein:
the as-synthesized core-shell particle comprises a core and shell;
the shell comprises an inner layer proximal to the core and an outer layer distal from the core; and
the molar concentration of second metal in the inner layer is about 1% to about 50% higher than the molar concentration of the second metal in the outer layer.

37. The method of claim 36, wherein:
the second metal is Ni; and
the molar concentration of Ni in the inner layer is about 1% to about 30% higher than the molar concentration of Ni in the outer layer.

38-39. (canceled)

40. The method of claim 1, wherein the as-synthesized core-shell particle comprises a core and shell;
the shell comprises an inner layer proximal to the core and an outer layer distal from the core;
the shell further comprises a third metal that is different from the second metal; and
the molar concentration of third metal in the inner layer is about 1% to about 50% lower than the molar concentration of the second metal in the outer layer.

41. The method of claim 40, wherein:
the third metal is Co; and
the molar concentration of Co in the inner layer is about 1% to about 50% lower than the molar concentration of Co in the outer layer.

42-46. (canceled)

47. A particle comprising a core and shell, wherein;
the core comprises a first metal;
the shell comprises an inner layer proximal to the core and an outer layer distal from the core;
the shell comprises a second metal; and
the molar concentration of the second metal in the inner layer is about 1% to about 50% higher than the molar concentration of the second metal in the outer layer.

48.-49. (canceled)

50. The particle of claim 47, wherein the first metal is selected from the group consisting of Ni, Mn, Co, Nb, Mg, and Fe, or a combination of any of them

51. The particle of claim 50, wherein the first metal is Ni or Mn.

52. (canceled)

53. The particle of claim 47, wherein the second metal is selected from the group consisting of Ni, Co, Mn, Li, Mg, Al, and Fe, or a combination of any of them.

54.-55. (canceled)

56. The particle of claim 47, wherein the shell further comprises a third metal and wherein the third metal is different from the second metal, and wherein the molar concentration of the third metal in the inner layer is about 5% to about 25% lower than the molar concentration of the third metal in the outer layer.

57-59. (canceled)

60. The particle of claim 56, wherein the third metal is Co.

61. The particle of claim 47, wherein
the core comprises Ni; and the shell comprises Li, Ni, Mn, and Co, or
the core comprises Mn; and the shell comprises Li, Ni, Mn, and Co.

62.-71. (canceled)
